(19) United States
(12) Patent Application Publication
(10) Pub. No.: US 2013/0018809 A1
(43) Pub. Date: Jan. 17, 2013

(54) COMPUTER-IMPLEMENTED METHOD AND SYSTEM FOR EVALUATING ECO-FUNCTIONAL PROPERTIES OF A PRODUCT

(71) Applicants: Yi LI, Hong Kong (HK); Subramanian Senthilkannan Muthu, Hong Kong (HK); Junyan Hu, Hong Kong (HK)

(72) Inventors: Yi LI, Hong Kong (HK); Subramanian Senthilkannan Muthu, Hong Kong (HK); Junyan Hu, Hong Kong (HK)

(21) Appl. No.: 13/182,792

(22) Filed: Jul. 14, 2011

(51) Int. Cl. G06Q 99/00

(52) U.S. Cl. 705/317

(57) ABSTRACT

A computer-implemented method for evaluating eco-functional properties of a product, comprising: providing four inputs including raw materials, process of manufacture, functional properties and ecological properties of the product; providing five outputs including Quality, Functionality, Human Impact, 3R's (Reduce, Recycle, Reuse), and Environmental Impact; connecting the inputs and outputs using predetermined rules to generate an eco-functional model; and wherein the eco-functional properties of the product are evaluated using the eco-functional model to derive an Eco-Functional Index which is computed by the equation: ΣESI+HTI+EII+FI+Eco-I, where ESI is an Ecological Sustainability Index, EII is an Environmental Impact Index, HTI is a Human Toxicity Index, FI is a Functionality Index and Eco-I is an Ecological Index.

### TECHNICAL FIELD

The invention concerns a computer-implemented method and system for evaluating eco-functional properties of a product. A single platform quantifies ecological and functional properties of the product.

### BACKGROUND OF THE INVENTION

Textiles have physical, chemical, functional, mechanical, comfort, aesthetic, ecological, thermal properties and so forth. Some of these properties are interrelated and have more significance than others. Functional properties have greater attraction since functionality is the base to decide the useful life of a product. A designer needs to design a product with functionality in mind first before considering other properties.

Another property which has equal significance to functionality is ecological property. The ecological property is the only property that covers a product from beginning to end. Ecological properties trace the products through its life cycle starting from raw material extraction until disposal. This is important because the environmental impact of each product manufactured needs to be considered.

Reduce, Reuse and Recycle (3R's) implies reduction of waste, energy, materials, other resources, ability to be reused many times and finally to be recycled once they become useless. This first strategy will try to prevent the product from reaching the landfill very quickly which is problematic to environmental scientists. The second strategy is if the material reaches the landfill, it should not pose any serious effects on the environment, and it must easily biodegrade.

The concept of sustainability can be defined in many ways. A definition given by the World Commission on Environment and Development is, “development that meets the needs of the present without compromising the ability of future generations to meet their own needs” (1). Sustainability is the concept of using the renewable or replenishable resources and not exhausting all the potential resources to the detriment of future generations.

A tool to assess the environmental impact of a product is “Life Cycle Assessment (LCA)”. It is an analytical tool which can help in understanding the environmental impact from the acquisition of raw materials to final disposal (2). In accordance to the definition given by The Society of Environmental Toxicology and Chemistry (SETAC), LCA is an iterative process to evaluate the environmental burdens associated with a product, process or activity by identifying and quantifying energy and materials used and wastes released to the environment; to assess the impact of those energy and material used and released to the environment; and to identify and evaluate opportunities to effect environmental improvements. The assessment includes the entire life cycle of the product, process or activity, encompassing extracting and processing raw materials; manufacturing, transportation and distribution, use, reuse, maintenance, recycling and final disposal (3).

It is important for a designer or any product to design a product in such a way that it possesses excellent functional properties with equal consideration to the environmental impacts made by the product as well. In other words, the designed product should create a negligible amount of environmental impact, which can be done by selecting raw materials, energy sources, and chemicals from renewable resources and create less environmental burden. Also the product must enable itself to be reused many times, to be recycled and to be disposed of easily and safely into a landfill at the end of its entire useful life. A designer must look into the absolute aspects of Eco-Functional properties of the product before designing it.

Eco-functional performance of any product is of significant importance. Therefore it is desirable to provide a model from which eco-functional capabilities of any product can be assessed and a score/grade can be assigned for any textile or product.

### SUMMARY OF THE INVENTION

In a first preferred aspect, there is provided a computer-implemented method for evaluating eco-functional properties of a product, comprising:
providing four inputs including raw materials, process of manufacture, functional properties and ecological properties of the product;
providing five outputs including Quality, Functionality, Human Impact, 3R's (Reduce, Recycle, Reuse), and Environmental Impact;
connecting the inputs and outputs using predetermined rules to generate an eco-functional model; and
wherein the eco-functional properties of the product are evaluated using the eco-functional model to derive an Eco-Functional Index which is computed by the equation: ΣESI+HTI+EII+FI+Eco-I, where ESI is an Ecological Sustainability Index, EII is an Environmental Impact Index, HTI is a Human Toxicity Index, FI is a Functionality Index and Eco-I is an Ecological Index.

The product may be a textile product.

The EII may be computed by the equation: ΣCPFI+ERFPI+ELUI, where CFPI is a Carbon Foot Print Index, ERFPI is an Ecological Resources Foot Print Index and ELUI is an Environmental Load Unit Index.

The FI may be computed by the equation: ΣQI+SI+HSI+PI+CFI+IRI, where SI is a Strength Index, IRI is an Impact Resistance Index, HIS is a Human Safety Index, PI is a Permeability Index, CFI is a Colour Fastness Index, and QI is a Quality Index.

The Eco-I may be computed by the equation: ΣBI+RUI+RC, where BI is a Biodegradability Index, RUI is a Reusability Index and RCI is a Recyclability Index.

The predetermined rules to connect the inputs and the outputs may be any one from the group consisting of:
the raw materials input is connected to the environmental impact output;
the raw materials input is connected to the 3R's output;
the raw materials input is connected to the Human Impact output;
the process of manufacture input is connected to the Human Impact output and Environmental Impact output;
the functional properties input is connected to the Quality output and Functionality output; and
the ecological properties input is connected to the Human Impact output, Environmental Impact output and 3R's output.

The Environmental Impact output may include Eco-Damage, ecological footprint and carbon footprint.

The raw materials input may be quantified by the EII and the ESI.

The ecological properties input may be quantified by RUI, RCI, and BI.

In a second aspect, there is provided a system for evaluating eco-functional properties of a product, comprising:
an input module to receive four inputs including raw materials, process of manufacture, functional properties and ecological properties of the product;
an output module to generate five outputs including Quality, Functionality, Human Impact, 3R's (Reduce, Recycle, Reuse), and Environmental Impact;
a processing module to connect the inputs and outputs using predetermined rules to generate an eco-functional model; and
wherein the eco-functional properties of the product are evaluated using the eco-functional model to derive an Eco-Functional Index which is computed by the equation: ΣESI+HTI+EII+FI+Eco-I, where ESI is an Ecological Sustainability Index, EII is an Environmental Impact Index, HTI is a Human Toxicity Index, FI is a Functionality Index and Eco-I is an Ecological Index.

The present invention combines both functional and ecological properties in a single platform. This single platform is referred to as an Eco-Functional Model. The functional and ecological properties are interrelated in the sense that the functionality of a product governs the ecological properties of the same product. For example, a product that assumes better functionality delays the disposal of the same by means of giving longer life to the product under consideration and also delays the arrival of another similar but new product using raw materials, using energy to manufacture, labour, chemicals, and also avoids the disposal issues of the new product. The present invention provides such links between the functional and ecological properties.

The present invention is a method to evaluate the eco-functional properties of products, in particular, textile products and to assign an Eco-Functional Index/score to any type of product, in particular, a textile product such as shopping bags. The Eco-Functional Index enables grading of any product to deduce any solid conclusion about the environmental impact made by that product. Consequently, the present invention enables quantification of the eco-functional properties of any product using a single platform.

### BRIEF DESCRIPTION OF THE DRAWINGS

An example of the invention will now be described with reference to the accompanying drawings, in which:

FIG. 1 is a structural diagram of a eco-functional model for evaluating the eco-functional properties in accordance with an embodiment of the present invention;

FIG. 2 is a theoretical framework diagram of the eco-functional model of FIG. 1 in accordance with an embodiment of the present invention;

FIG. 3 is a chart depicting Environmental Impact Index (EII) and Ecological Sustainability Index (ESI) of textile fibers;

FIG. 4 is a process flow diagram depicting a process to obtain a final result R_{Product} in accordance with an embodiment of the present invention;

FIG. 5 is a process flow diagram depicting the process to derive the Eco-Functional Index in accordance with an embodiment of the present invention;

FIG. 6 is a structural diagram of a structure of the environmental impact and sustainability model in accordance with an embodiment of the present invention; and

FIG. 7 is a chart depicting Y₇ Values.

### DETAILED DESCRIPTION OF THE DRAWINGS

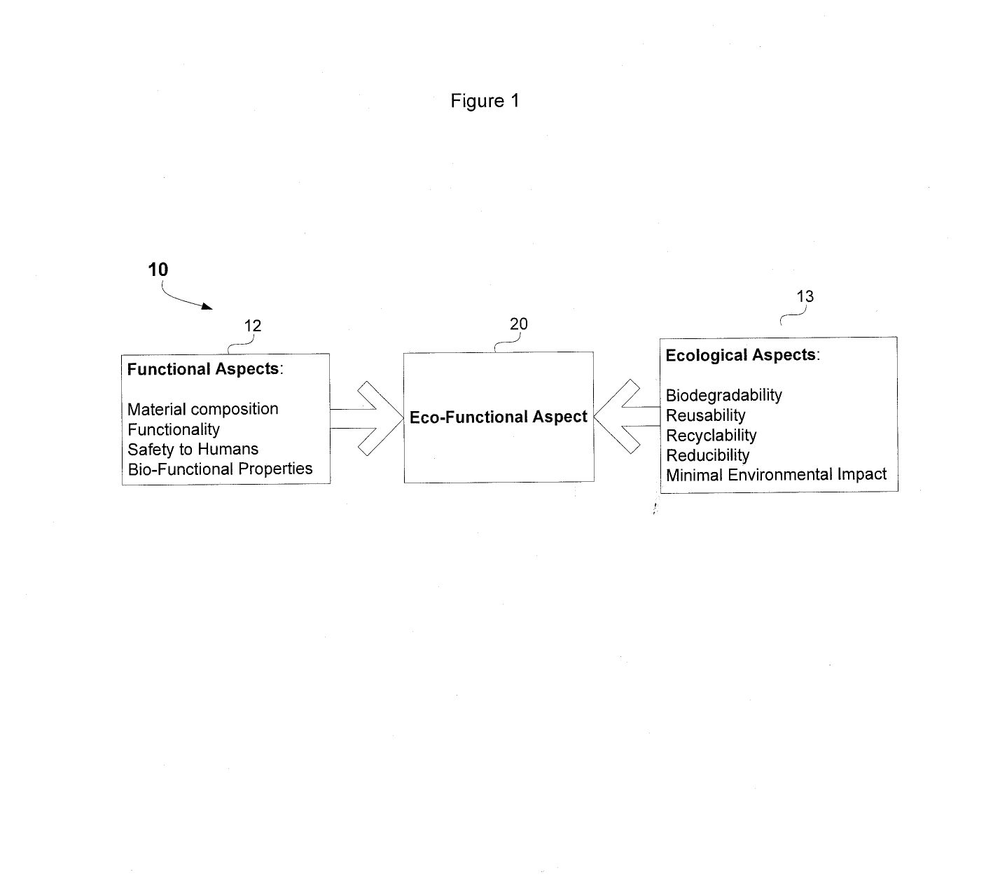

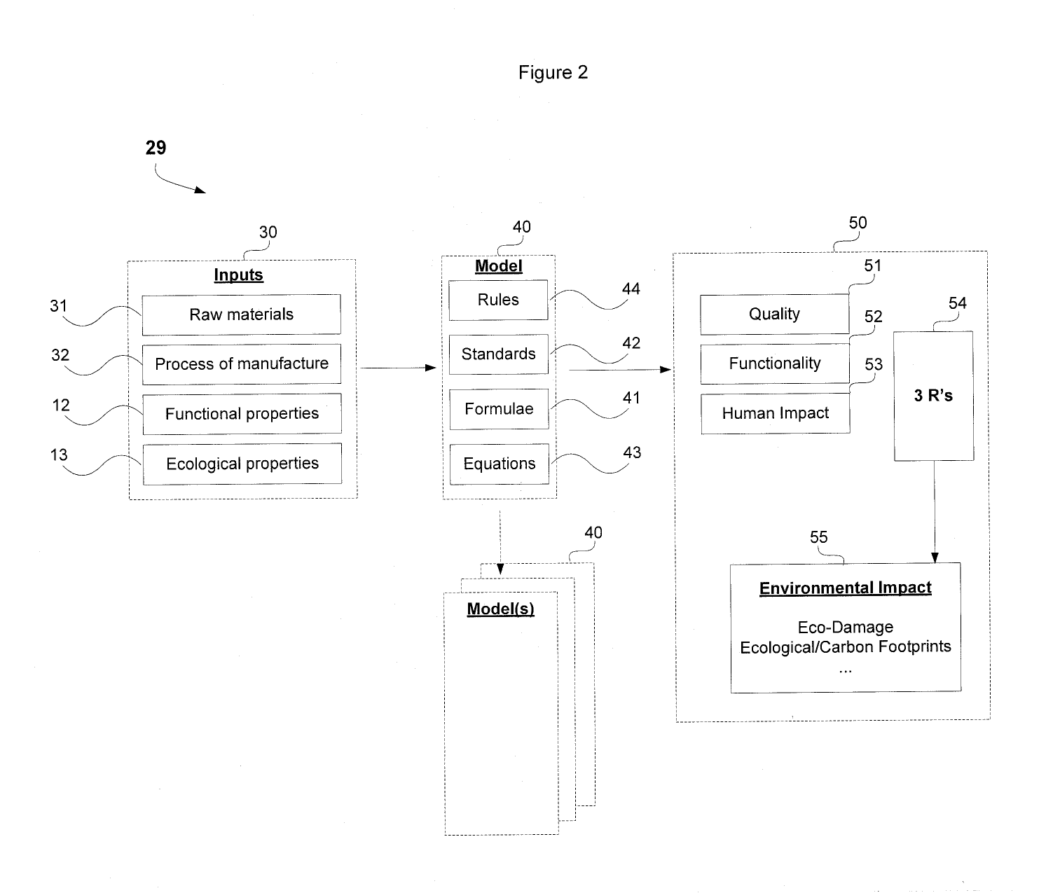

Referring to FIGS. 1 and 2, a system 10 and process to quantify the eco-functional properties 20 of textile products is provided. The system 10 has models 40 which create an eco-functional model framework 29 with four inputs 30 and five outputs 32 to evaluate the eco-functional properties 20 of textile products. The model 40 has four inputs 30 including raw materials 31, process of manufacture 32, functional properties 12 and ecological properties 13. It also includes five outputs 32, such as quality 51, functionality 52, human impact 53, 3R's 54 and environmental impact 55. The environmental impact 55 includes carbon footprint, ecological footprint and eco damage and so forth. The model 40 combines ecological properties 13 and functional properties 12.

Formulas 41, standards 42, equations 43 and rules 44 for this framework 29 are established in each of the models 40. According to the results calculated from the model 40, it is possible to determine the quality and functionality 32 of products and obtain an indication of the impact to humans and the environment including carbon emissions.

The ability of products to follow the concept of 3R's (Reduction-, Reuse and Recycle) 54 can also be further analyzed. This enables calculation of the eco-damage or carbon footprint and/or the ecological footprint 55 of the product. The process, the inputs 39 and the outputs 50 are linked which is shown in Table 1.

TABLE 1

| Inputs | Outputs | Ways of Connection |
|---|---|---|
| 1. Raw materials and their associated | 1. 3 R's | All of the three will be |
| parameters such as extraction, production, | 2. Human Impact | connected by a set of rules. |
| and performance of raw materials in the | 3. Environmental | |
| context of environmental impact and | Impact | |
| ecological sustainability | | |
| 2. Process of manufacturing which includes | 1. Human Impact | 1. Human Toxicity by formulae/ |
| consumption of materials, chemicals, | 2. Environmental | equations |
| auxiliaries, energy and water consumption, | Impact | 2. Environmental Impact by |
| discharge of pollutants to air, water, land | | formulae/equations |
| and solid waste and so on | | |
| 3. Functional properties of textile products, | 1. Quality | Both of the outputs will be |
| including physical, mechanical, chemical, | 2. Functionality | connected by simple rules |
| handle properties and so on. | | |
| 4. Ecological properties of textile products | 1. 3 R's | All of the three will be |
| such as biodegradability, recyclability and | 2. Human Impact | connected by a set of rules. |
| reusability. | 3. Environmental | |
| | Impact | |

The model 40 is applied to any product, in particular, textiles. For example, shopping bags are considered to evaluate the concept of eco-functional. Currently available life cycle models discussed in ISO 14040 standards and commercial models developed will not include the functional considerations for calculation of environmental impacts. Also, other factors such as ability of the fiber/material to biodegrade, recyclable, reusable are not included. 3R's 54 have been included in the model 40. This model 40 also takes into account ecological sustainability of textile fibers for the calculation of environmental impact, which conventional life cycle models cannot.

Problems with conventional life cycle models include normalization, weighing, and single score evaluation are that they are very complicated and controversial. The model 40 avoids these problems or has simplified them in the model 40. Consequently, the model 40 enables evaluation of the entire life of a textile product with the inclusion of all relevant factors being included with due consideration. Connection of inputs 30 and outputs 50 with predetermined rules are generated from simple rules, simplified life cycle impact characterization equations, relevant standards pertaining to the functional and ecological properties of textile products. Also, the model 40 enables quantification and derivation of Recyclability Potential Index (RPI) for textile fibers. The model 40 also enables derivation of indices for ecological properties 13 and functional properties 12. Evaluation of shopping bags/textile products with a five point scale to derive their Eco-Functional Index with the aid of many indices in ecological and functional fronts, is provided by the model 40.

### Inputs for the Eco-Functional Model

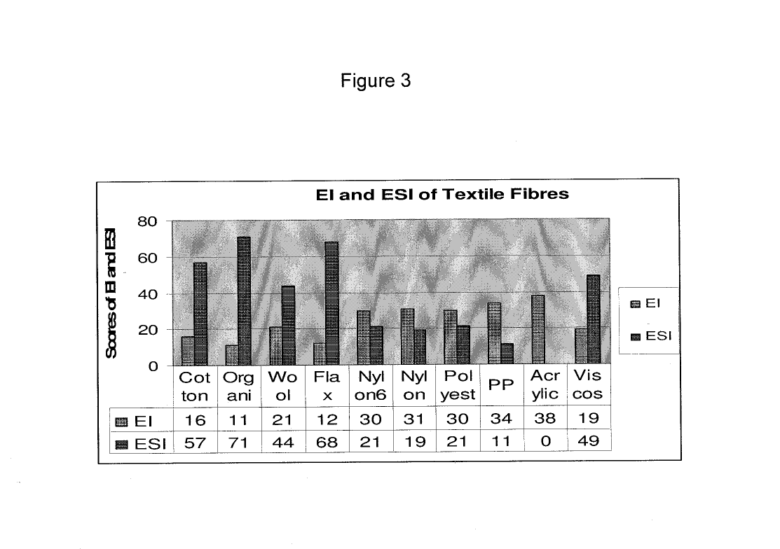

The first input for the model 40 is the fiber/raw material 31 used for the manufacture of the end product, i.e. shopping bags or any other textile product. To quantify this, a separate model is provided. The model 40 quantifies the environmental impact made by textile fibers and to derive the Environmental Impact Index (EII) and Ecological Sustainability Index (ESI). The results of this model in terms of EII and ESI of different textile fibers are depicted in FIG. 3

The other considerations to be given in the fiber/raw material input are the Environmental Analysis of Textile Manufacturing with regards to Fibers, which is shown in Table 2 below:

TABLE 2
Environmental Analysis of Textile Fibers (4)

| | Nonpolluting to | Made From | | |
|---|---|---|---|---|
| Textile | obtain, Process, | Renewable | Fully Bio | Reusable/ |
| Product | and Fabricate | resources | degradable | Recyclable |
| Cotton* | No | Yes | Yes | Yes |
| | Fertilizers, | Cotton Comes from | | But it is difficult to |
| | herbicides, | cotton plants that | | recycle cotton from |
| | pesticides, dyes | are renewable | | postconsumer |
| | and chemicals used | | | products because of |
| | can pollute air, | | | the presence of dyes |
| | water and soil | | | and other fibers |
| Wool* | No | Yes | Yes | Yes |
| | Runoff | Wool comes from | | It can be recycled |
| | contamination, | sheep, which are | | |
| | Chemicals used for | renewable | | |
| | cleaning, dyeing, | | | |
| | and finishing can | | | |
| | cause pollution | | | |
| Rayon* | No | No | Yes | Yes |
| | Harsh Chemicals | Wood pulp used for | | But Rayon fibers |
| | used to process | rayon comes from | | have not been |
| | wood pulp and dyes | mature forest | | recycled |
| | and finishing | | | |
| | chemicals can | | | |
| | cause pollution | | | |
| Tencel* | No | Yes | Yes | Yes |
| | Chemicals used for | Trees used for | | But Tencel has not |
| | dyeing and finishing | Tencel are | | been recycled |
| | can cause pollution | replanted | | |
| Polyester* | No | No | No | Yes |
| | Chemicals used for | Petroleum | | 100% PET has been |
| | dyeing and finishing | resources are not | | recycled |
| | can cause pollute | renewable | | |
| | air & water | | | |
| Nylon* | No | No | No | Yes |
| | Chemicals used for | Petroleum | | 100% Nylon has |
| | dyeing and finishing | resources are not | | been recycled |
| | can cause pollute | renewable | | |
| | air & water | | | |
| Olefins | No | No | No | Yes |
| | Chemicals used for | Petroleum | | 100% PP/PE has |
| | dyeing and finishing | resources are not | | been recycled |
| | can cause pollute | renewable | | |
| | air & water | | | |

The second input for the model 40 is the process of manufacture 32 that is used. The entire textile process used to manufacture a particular type of shopping bag is studied in terms of process production lines. This includes quantity of water, energy required, additives, raw materials used and amount of airborne wastes, solid, liquid and other wastes emitted.

The third input for the model 40 is the functional properties 12 of textile products (for example, shopping bags), which can be taken from the results of the tests, which is shown in Table 3 below:

TABLE 3
Functional Properties

| | |
|---|---|
| Material Composition | ISO 1833-1/FTIR/HPLC |
| Tensile strength and elongation | ASTM D 5034 Grab Test |
| Tear strength | Elmendorf tear test ASTM D 5734 |
| Thickness | ISO 5084 |
| Weight | ISO 9073-1:1989 |
| Bursting strength | ISO 13938-2 |
| Colour fastness to friction | ISO 105-X12 |
| Colour fastness to washing | ISO 105-C10:2006 |
| Colour fastness to water | ISO 105-E01:2010 |
| Colour fastness to perspiration | ISO 105-E04:2008 |
| Colour fastness to light | ISO 105-B 02 (BWS 4) |
| Impact Resistance and Toughness | Eco-functional Tester |
| Load Carrying capacity | Eco-functional Tester |
| Ph | ISO 3071 |
| Formaldehyde | ISO 14184-1 |
| Air permeability | ISO 9237 |
| Water proof | AATCC 127 |
| Water Vapour Permeability | ASTM E 96 |

The last input for the model 40 is the ecological properties 13 of shopping bags, which is shown in Table 4 below:

TABLE 4
Ecological Properties

| | |
|---|---|
| Biodegradation of material | AATCC 30 |
| Reusability | Eco-functional Tester |
| Recyclability | Developed. |

For the quantification of reusability of shopping bags, an Eco-functional Tester instrumented is provided to evaluate the reusability, impact strength and load bearing capacity of shopping bags.

The various inputs 30 and outputs 50 selected for the model 40 are linked. For the fiber/raw material input 31, there are three cases described. In the first case, an Ecological Sustainable Index Rank (R_{ESIR}) and ability to biodegrade (R_{BIO}) are used as the inputs for the first case with the output 55 of Environmental impact (R_{EI}) selected. Table 5 below enumerates the inference rules for this case:

TABLE 5
Case 1 for the fiber/raw material input

| Rule No. | IF R_{ESIR} is | Operand | R_{BIO} is | THEN | R_{EI} is |
|---|---|---|---|---|---|
| 1 | 1 | | | | Close to None |
| 2 | 2 | | | | Very Less |
| 3 | 3 | | | | Less |
| 4 | 4 | | | | Moderately less |
| 5 | 5 | | | | Moderate |
| 6 | 6 | | | | Moderately high |
| 7 | 7 | | | | High |
| 8 | 8 | | | | Very High |
| 9 | 9 | | | | Extreme |
| 10. | 10 | | | | Extremely High |
| 11. | 1 | | No | | High |
| 12 | 10 | | Yes | | Less |
| 13 | 1 | | Yes | | Close to None |
| 14 | 10 | | No | | Extremely High |

In the second case, the ecological Sustainable Index Rank (R_{ESIR}) and Ability to Recycle/reuse (R_{AR}) are used as the inputs with the output 54 of 3R's (R₃ᵣ) selected. The following Table 6 enumerates the inference rules for this case:

TABLE 6
Case 2 for the fiber/raw material input

| Rule No. | IF R_{ESIR} is | Operand | R_{AR} is | THEN | R₃ᵣ is |
|---|---|---|---|---|---|
| 1 | 1 | | | | Reduction in |
| | | | | | Unsustainability |
| 2 | 1 | AND | Yes | | Reduce/ |
| | | | | | reuse/recycle |
| 3 | 1 | AND | No | | Less Reduce/ |
| | | | | | reuse/recycle |
| 4 | 9 | | | | Reduction in |
| | | | | | Sustainability |

In the third case, the Ecological Sustainable Index Rank (R_{ESIR}) and Non Polluting Process (R_{NP}) are used as the inputs with the output 53 of Human Impact (R_{HI}) selected. The following Table 7 enumerates the inference rules for this case:

TABLE 7
Case 3 for the fiber/raw material input

| Rule No. | IF R_{ESIR} is | Operand | R_{NP} is | THEN | R_{HI} is |
|---|---|---|---|---|---|
| 1 | 1 | | | | Close to None |
| 2 | 2 | | | | Very Less |
| 3 | 3 | | | | Less |
| 4 | 4 | | | | Moderately less |
| 5 | 5 | | | | Moderate |
| 6 | 6 | | | | Moderately high |
| 7 | 7 | | | | High |
| 8 | 8 | | | | Very High |
| 9 | 9 | | | | Extreme |
| 10 | 10 | | | | Extremely High |
| 11 | 1 | | No | | High |
| 12 | 10 | | Yes | | Very High |
| 13 | 1 | | Yes | | Close to None |
| 14 | 10 | | No | | Extremely High |

For the process of manufacture input 32, the relevant outputs 50 to be connected are: Human Impact−Human Toxicity Potential and Environmental Impact (from LCA). For the Environmental Impact (from LCA), the following are included: Carbon footprint, Ecological footprint, Environmental burden−Emissions, and Environmental burden−Resources. Both outputs 53, 55 are connected by the equations below (5):

To calculate Human Toxicity=ΣᵢΣ_{ecom}HTP_{ecom,i}*M_{ecom,i}

The indicator result is expressed in kg 1, 4-dichlorobenzene equivalent. HTP_{ecom,i} is the Human Toxicity Potential (the characterisation factor) for substance i emitted to the emission compartment ecom (=air, fresh water, sea water, agricultural soil or industrial soil), while m_{ecom,i} is the emission of substance i to medium ecom.

Environmental Impact 55 is calculated by calculating Climate Change (carbon footprint), Ecological Footprint (Depletion of Abiotic Resources) and Environmental burden−Emissions.

Climate Change (carbon footprint) is calculated using Global Warming Index=Σᵢeᵢ×GWPᵢ, where eᵢ is the emission (in kilograms) of substance i and GWP is the global warming potential of substance i.

Ecological Footprint (Depletion of Abiotic Resources) is calculated using Abiotic Depletion=ΣᵢADPᵢ*mᵢ, where, ADPᵢ is the Abiotic Depletion Potential (in kilograms) of Resourceᵢ and mᵢ (kg, except for natural gas and fossil fuel energy) is the quantity of resource i used.

Environmental burden−Emissions is calculated using Environmental Burden=ΣᵢFactorᵢ*mᵢ. The total environmental burden is expressed in Environmental Load Units. Factorᵢ(ELU.kg⁻¹) is the valuation weighing factor for the EPS method for the resource i, while mᵢ is the quantity of resource i used.

For functional properties input 12, the following Table 8 gives the linkage to relevant outputs 50:

TABLE 8
Linkage of outputs to the functional input

| Test | Criteria | Output |
|---|---|---|
| Material Composition | GOOD (Meets the Declaration) | Quality (R_{Q}) |
| Tensile strength and elongation | GOOD (Meets the Requirement) | Functionality (R_{F)} |
| Tear strength | GOOD (Meets the Requirement) | Functionality (R_{F)} |
| Thickness | GOOD (Meets the Requirement) | Functionality (R_{F)} |
| Weight | GOOD (Meets the Requirement) | Quality (R_{Q}) |
| Bursting strength | GOOD (Meets the Requirement) | Quality (R_{Q}) |
| Colour fastness to friction | GOOD (Meets the Requirement) | Functionality (R_{F)} |
| Colour fastness to washing | GOOD (Meets the Requirement) | Functionality (R_{F)} |
| Colour fastness to water | GOOD (Meets the Requirement) | Functionality (R_{F)} |
| Colour fastness to perspiration | GOOD (Meets the Requirement) | Functionality (R_{F)} |
| Colour fastness to light | GOOD (Meets the Requirement) | Functionality (R_{F)} |
| Impact Resistance and Toughness | GOOD (Meets the Requirement) | Human Safety (R_{HI}) |
| Load Carrying capacity | GOOD (Meets the Requirement) | Human Safety (R_{HI}) |
| Ph | GOOD (Meets the Requirement) | Human Safety (R_{HI}) |
| Formaldehyde | GOOD (Meets the Requirement) | Human Safety (R_{HI}) |
| Air permeability | GOOD (Meets the Requirement) | Functionality (R_{F)} |
| Water proof | GOOD (Meets the Requirement) | Functionality (R_{F)} |
| Water Vapour Permeability | GOOD (Meets the Requirement) | Functionality (R_{F)} |

The Human Impact output R_{HI} includes Human Safety and Human Toxicity.

For ecological properties input 13, the following Table 9 gives the linkage to relevant outputs 50:

TABLE 9
Linkage of outputs to the ecological properties input

| Test | Criteria | Output |
|---|---|---|
| Biodegradation of | GOOD (Meets | Reduced Human Toxicity (R_{HI}) |
| material | the Requirement) | Lesser Environmental Impact |
| Reusability | GOOD (Meets | Reduced Human Toxicity (R_{HI}) |
| | the Requirement) | Lesser Environmental Impact (R_{El}) |
| | | 3 R's (R_{3R's}) - Reusability |
| Recyclability | GOOD (Meets | Reduced Human Toxicity (R_{HI}) |
| | the Requirement) | Lesser Environmental Impact (R_{EI}) |
| | | 3R's (R_{3R's}) - Recyclability |

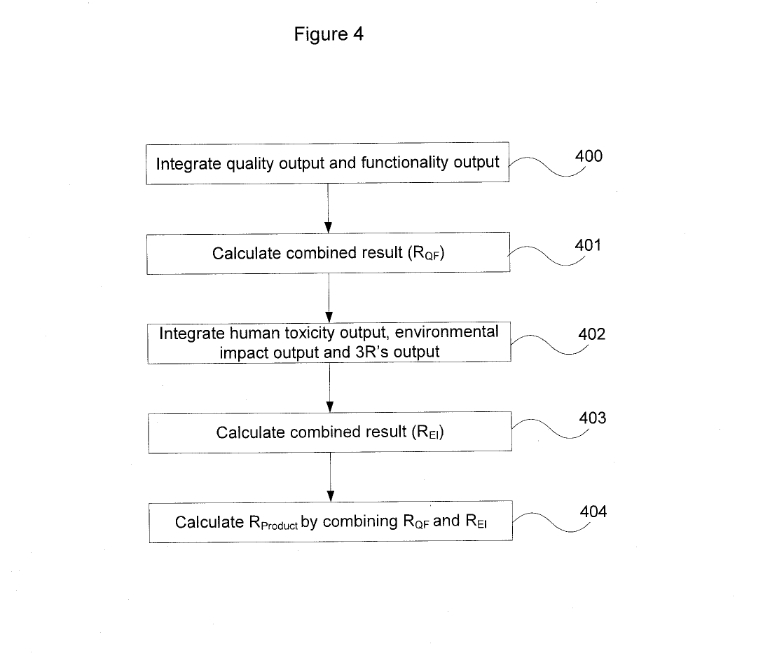

Referring to FIG. 4, to obtain a final result R_{Product}, three steps are required. The first step is to integrate (400) the quality output 51 and functionality output 52 and calculate (401) the combined result (R_{QF}). The second step is to integrate (402) human toxicity output 53; environmental impact output 55 and 3R's output 54 and calculate (403) the combined result (R_{EI}). The last step is to combine R_{QF} and R_{EI} to calculate (404) R_{Product}, which is the desired result from the eco-functional model 40. From the final result of R_{Product}, it is possible to determine the position of any textile product/shopping bag in terms of eco-functionality.

Table 10 explains the connection between the quality output 51 and functionality output 52.

TABLE 10
Quality and Functionality

| Rule | | | | | |
|---|---|---|---|---|---|
| No. | IF | Operand | R_{Q}/R_{F} | THEN | R_{QF} |
| 1 | R_{Q} is PASS | AND | R_{F} is PASS | | GOOD |
| 2 | R_{Q} is PASS | AND | R_{F} is FAIL | | POOR |
| 3 | R_{F} is PASS | AND | R_{Q} is FAIL | | AVERAGE |

Table 11 explains the connection between the 3R's output 54, Environmental Impact output 55 and Human Impact output 53.

TABLE 11
3 R's, Environmental Impact, Human Impact

| Rule | | | | | |
|---|---|---|---|---|---|
| No. | IF | R_{EI} | R_{HI} | THEN | R_{EI} |
| 1 | R_{3R's} is PASS | R_{EI} is PASS | R_{HI} is PASS | | GOOD |
| 2 | R_{3R's} is FAIL | R_{EI} is FAIL | R_{HI} is FAIL | | POOR |
| 3 | R_{3R's} is PASS | R_{EI} is FAIL | R_{HI} is FAIL | | POOR |
| 4 | R_{3R's} is FAIL | R_{EI} is PASS | R_{HI} is FAIL | | POOR |
| 5 | R_{3R's} is FAIL | R_{EI} is FAIL | R_{HI} is PASS | | POOR |
| 6 | R_{3R's} is PASS | R_{EI} is PASS | R_{HI} is FAIL | | AVER- |
| | | | | | AGE |
| 7 | R_{3R's} is FAIL | R_{EI} is PASS | R_{HI} is PASS | | AVER- |
| | | | | | AGE |
| 8 | R_{3R's} is PASS | R_{EI} is FAIL | R_{HI} is PASS | | AVER- |
| | | | | | AGE |

The process of arriving at an overall result is shown in Table 12.

TABLE 12
overall result

| | | | | | |
|---|---|---|---|---|---|
| Rule | | | | | |
| No. | IF | Operand | R_{EIF}/R_{QF} | THEN | R_{Product} |

| | | | | |
|---|---|---|---|---|
| 1 | R_{QF} is GOOD | AND | R_{EIF} is GOOD | PASS |
| 2 | R_{QF} is GOOD | AND | R_{EIF} is POOR | FAIL |
| 3 | R_{QF} is | AND | R_{EIF} is POOR | FAIL |
| | AVERAGE | | | |
| 4 | R_{QF} is | AND | R_{EIF} is | MEDIUM |
| | AVERAGE | | AVERAGE | |
| 5 | R_{EIF} is | AND | R_{QF} is POOR | FAIL |
| | AVERAGE | | | |
| 6 | R_{QF} is GOOD | AND | R_{EIF} is | PASS |
| | | | AVERAGE | |
| 7 | R_{QF} is POOR | AND | R_{EIF} is GOOD | FAIL |
| 8 | R_{QF} is | AND | R_{EIF} is GOOD | PASS |
| | AVERAGE | | | |
| 9 | R_{QF} is POOR | AND | R_{EIF} is POOR | FAIL |

### Eco-Functional Index

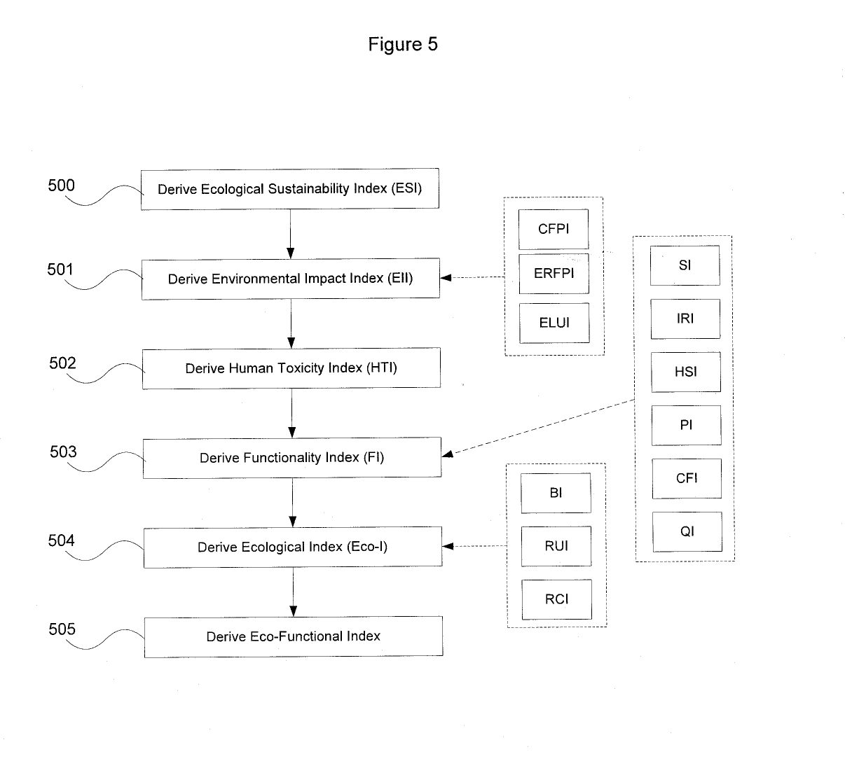

Referring to FIG. 5, an Eco-Functional Index/score of any textile product is derived by using the model 40. This is the final index that is derived. The Eco-Functional Index is numerical which portrays the ability of the product in terms of its eco-functionality. A separate index/index system is created from a grading scheme for each input 30 and finally by combining the results of the indices from all the four inputs 30. The steps to arrive at the Eco-Functional Index for evaluating the eco-functional properties of the product using the eco-functional model 40 are described below.

The Ecological Sustainability Index (ESI) index must be derived (500) to calculate the Eco-Functional Index. The ESI is based on the results of ESI values shown in Table 13. The grading system pertaining to ESI is shown below in Table 13.

The Ecological Sustainability Index (ESI) values and its Ranking (E_{SIR}) is shown below:

TABLE 13
ESI results

| Fiber | ESI | E_{SIR} |
|---|---|---|
| Cotton | 57 | 3 |
| Organic Cotton | 71 | 1 |
| Wool | 44 | 5 |
| Flax | 68 | 2 |
| Nylon6 | 21 | 6 |
| Nylon 66 | 19 | 7 |
| Polyester | 21 | 6 |
| Polypropylene (PP) | 11 | 8 |
| Acrylic | 0 | 9 |
| Viscose | 49 | 4 |

TABLE 14
Grading system for ESI

| ESI | Index |
|---|---|
| 1-2 | 5 |
| 3-4 | 4 |
| 5-6 | 3 |
| 7-8 | 2 |
| 9-10 | 1 |

The Human Toxicity Index (HTI) and Environmental Impact Index (EII)) must also be derived (502, 501) to calculate the Eco-Functional Index. The grading system for deriving at HTI and EII are tabulated in Table 15.

The Environmental Impact Index (EII) is derived (501) by ΣCFPI+ERFPI+ELUI where CFPI is the Carbon Foot Print Index (CFPI), ERFPI is the Ecological Resources Foot Print Index and ELUI is the Environmental Load Unit Index.

TABLE 15
Grading system for HTI and EII
Human Toxicity Index (HTI)

| | |
|---|---|
| <20% | 5 |
| 20.1-40% | 4 |
| 40.1-60% | 3 |
| 60.1-80% | 2 |
| 80.1-100% | 1 |

Ecological Resources Foot Print Index (ERFPI)

| | |
|---|---|
| <20% | 5 |
| 20.1-40% | 4 |
| 40.1-60% | 3 |
| 60.1-80% | 2 |
| 80.1-100% | 1 |

Carbon Foot Print Index (CFPI)

| | |
|---|---|
| <20% | 5 |
| 20.1-40% | 4 |
| 40.1-60% | 3 |
| 60.1-80% | 2 |
| 80.1-100% | 1 |

Environmental Load Unit Index (ELUI)

| | |
|---|---|
| <20% | 5 |
| 20.1-40% | 4 |
| 40.1-60% | 3 |
| 60.1-80% | 2 |
| 80.1-100% | 1 |

Environmental Impact Index (EII)

| | |
|---|---|
| 13-15 | 5 |
| 10-12 | 4 |
| 7-9 | 3 |
| 4-6 | 2 |
| <3 | 1 |

The Functionality index (FI)) must also be derived (503) to calculate the Eco-Functional Index. The FI is the resultant index of many sub indices, which are discussed below in Tables 16 to 20. The grading system for deriving at FI is tabulated in Table 20. The sub-indices are: Strength Index (SI), Impact Resistance Index (IRI), Human Safety Index (HSI), Permeability Index (PI), Colour Fastness Index (CFI), Quality Index (QI). The Functionality Index (FI) is derived by ΣQI+SI+HSI+PI+CFI+IRI.

TABLE 16
Grading system for Strength Index (SI)
Tensile Strength Index

| | |
|---|---|
| 80.1-100% | 5 |
| 60.1-80% | 4 |
| 40.1-60% | 3 |
| 20.1-40% | 2 |
| <20% | 1 |

Bursting Strength Index

| | |
|---|---|
| 80.1-100% | 5 |
| 60.1-80% | 4 |
| 40.1-60% | 3 |
| 20.1-40% | 2 |
| <20% | 1 |

Tear Strength Index

| | |
|---|---|
| 80.1-100% | 5 |
| 60.1-80% | 4 |
| 40.1-60% | 3 |
| 20.1-40% | 2 |
| <20% | 1 |

Strength Index (SI) = Σ Tensile Strength Index + Tear Strength Index + Bursting Strength Index

TABLE 17
Grading system for Human Safety Index (HSI)
Ph Index

| | |
|---|---|
| 4-9 | 5 |
| <4 | 1 |

Formaldehyde Index

| | |
|---|---|
| <300 | 5 |
| >300 | 1 |

Human Safety Index (HSI) = Σ Ph Index + Formaldehyde Index

TABLE 18
Grading system for Permeability Index (PI)
Air permeability Index

| | |
|---|---|
| 80.1-100% | 5 |
| 60.1-80% | 4 |
| 40.1-60% | 3 |
| 20.1-40% | 2 |
| <20% | 1 |

Water vapour permeability Index

| | |
|---|---|
| 80.1-100% | 5 |
| 60.1-80% | 4 |
| 40.1-60% | 3 |
| 20.1-40% | 2 |
| <20% | 1 |

Permeability Index (PI) = Σ Air permeability Index + Water vapour permeability Index

TABLE 19
Grading system for Colour Fastness Index (CFI)
Colour Fastness Index

| | |
|---|---|
| 5 | 5 |
| 4-5 | 4 |
| 3-4 | 3 |
| 2-3 | 2 |
| <2 | 1 |

Colour Fastness Index (CFI) = Σ Colour Fastness to Rubbing Index + Colour Fastness to Water Index + Colour Fastness to Washing Index + Colour Fastness to Alkali Perspiration Index + Colour Fastness to Acid Perspiration Index
Permeability Index = Σ Air permeability Index + Water vapour permeability Index

TABLE 20
Grading system for Functionality Index (FI)
Strength Index (SI)

| | |
|---|---|
| 13-15 | 5 |
| 10-12 | 4 |
| 7-9 | 3 |
| 4-6 | 2 |
| <3 | 1 |

Human Safety Index (HSI)

| | |
|---|---|
| 10 | 5 |
| 6 | 3 |
| 2 | 1 |

Colour Fastness Index (CFI)

| | |
|---|---|
| 26-30 | 5 |
| 21-25 | 4 |
| 16-20 | 3 |
| 11-15 | 2 |
| <10 | 1 |

Impact Resistance Index (IRI)

| | |
|---|---|
| >5 | 5 |
| 4 | 4 |
| 3 | 3 |
| 2 | 2 |
| 1 | 1 |

Permeability Index (PI)

| | |
|---|---|
| 9-10 | 5 |
| 7-8 | 4 |
| 5-6 | 3 |
| 3-4 | 2 |
| 1-2 | 1 |

Quality Index - Material Composition (QI)

| | |
|---|---|
| Pass | 5 |
| Fail | 1 |

Functionality Index (FI)

| | |
|---|---|
| 26-30 | 5 |
| 21-25 | 4 |
| 16-20 | 3 |
| 11-15 | 2 |
| <10 | 1 |

The Ecological Index (Eco-I) must also be derived (504) to calculate the Eco-Functional Index. The Eco-I is the resultant index of other three sub indices, which are described below in Table 21. The grading system for deriving the Eco-I is tabulated in Table 21. The sub-indices are: Biodegradability Index (BI), Reusability Index (RUI), and Recyclability Index (RCI). The Ecological Index (Eco-I) is derived by ΣBI+RUI+RC.

TABLE 21
Grading system for Ecological Index (Eco-I)
Biodegradability Index (BI)

| | |
|---|---|
| Pass | 5 |
| Fail | 1 |

Recyclability Index (RCI)

| | |
|---|---|
| Pass | 5 |
| Fail | 1 |

Reusability Index (RUI)

| | |
|---|---|
| 81-100 | 5 |
| 61-80 | 4 |
| 41-60 | 3 |
| 21-40 | 2 |
| 1-20 | 1 |

Ecological Index (Eco-I)

| | |
|---|---|
| 13-15 | 5 |
| 10-12 | 4 |
| 7-9 | 3 |
| 4-6 | 2 |
| <3 | 1 |

The Eco-Functional Index is the final result which is the aggregation of the individual scores/indices of each input 30. The Eco-functional Index is derived (505) by ΣESI+HTI+EII+FI+Eco-I, where ESI=Ecological Sustainability Index, EII=Environmental Impact Index, HTI=Human Toxicity Index, FI=Functionality Index and Eco-I=Ecological Index. The grading system for quantifying the Eco-functional Index is tabulated in Table 22 below:

TABLE 22
Grading system for Eco-functional Index
Eco-Functional Index

| | |
|---|---|
| 21-25 | 5 |
| 16-20 | 4 |
| 11-15 | 3 |
| 6-10 | 2 |
| <5 | 1 |

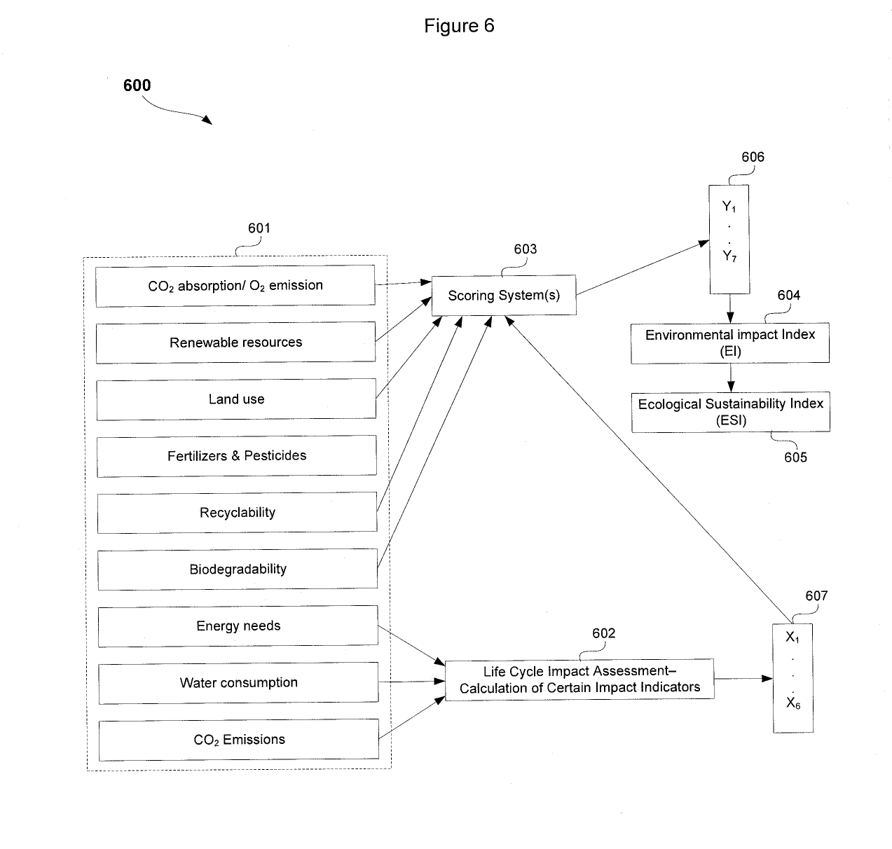

Referring to FIG. 6, the structure 600 of the Eco-Functional model 40 is depicted and the corresponding equations are given in equations 1 and 2. The photosynthesis effect (amount of oxygen produced), utilisation of renewable resources, land use, usage of fertilisers and pesticides, fiber recyclability and biodegradability are factors 601 considered. The energy, water requirements and CO₂ emissions are other factors 601 considered and the relevant values are studied. Considering these factors as a life cycle inventory, a Life Cycle Impact Assessment (LCIA) is carried out and certain impact categories 602, such as damage to human health, ecosystem quality and resources, which determine ecological sustainability, are chosen. A scoring system 603 is provided based on the values of all the factors 601 mentioned above and according to the values of impact categories calculated from LCIA 602. The Environmental Impact Index (EII) 604 is derived by equation 2 by summation of scores in each category result. From EII, the Ecological Sustainability Index (ESI) 605 is derived.

The Ecological Sustainability Index (ESI) 605 is mathematically expressed as follows:

EI=ΣαⱼYⱼ=α₁Y₁α₂Y₂α₃Y₃+α₄Y₄α₅Y₅+α₆Y₆+α₇Y₇ equation (1)

ESIₖ=(1−EIₖ/EIₘₐₓ)×100 equation (2)

where,
EI—Environmental Impact index,
EIₖ—Environmental impact index of the k^{th} fiber under consideration,
EIₘₐₓ—The gained maximum scores of Environmental impact index among the selected fibers,

### ESI—Ecological Sustainability Index (ESI),

ESIₖ—Ecological Sustainability Index of the k^{th} fiber under consideration,
αⱼ—Weighting coefficient for the j^{th} factor,
Y₁—CO₂ absorption/O₂ emission in fiber production ready for textile processing,
Y₂—Use of renewable resources in fiber production,
Y₃—Land use in fiber production ready for textile processing,
Y₄—Usage of fertilizers & pesticides in fiber production,
Y₅—Fiber recyclability,
Y₆—Fiber biodegradability
Y₇—EI_{LCIA}-LCIA Impact categories, which is defined as:

Y₇ΣβᵢXᵢ=β₁X₁+β₂X₂+β₃X₃

(X₁, . . . X₃)=f(x₁,x₂,x₃), i.e. X₁=f₁(x₁,x₂,x₃)

βᵢ—Weighting coefficient for the i^{th} LCIA indices

### X₁—Damage to Human Health

### X₂—Damage to Eco System Quality

### X₃—Damage to Resources

x₁—Energy consumption in fiber production ready for textile processing
x₂—Water consumption in fiber production ready for textile processing
x₃—CO₂ Emissions in fiber production ready for textile processing

Firstly, based on the data pertaining to the factors 601 photosynthesis effect (amount of oxygen produced), utilisation of renewable resources, land use, usage of fertilisers and pesticides, fiber recyclability and biodegradability, a set of scoring systems 603 (consists of numerical scores of 0 to 5 in all cases, except for photo synthesis effect (−1 to 5), based on the available results) is provided.

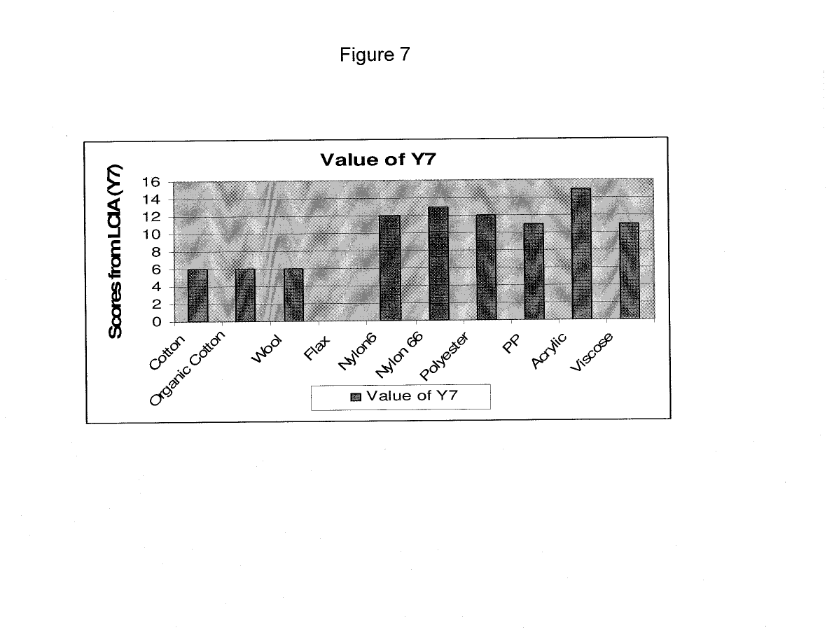

Secondly, based on the LCIA results 602 on the extent of damages created to human health, ecosystem quality and resources, another set of scoring system, (consists of numerical scores of 0 to 5 based on the available results) is provided. The scoring system corresponding to each category (Y₁ . . . Y₇) 606 is explained in detail below under the relevant sections. FIG. 7 depicts the Y7 values from the LCIA scoring system. As described in equation 1, EI 604 is derived as the summation of Y₁, Y₂ . . . Y₇. The higher the EI, the higher is the impact on environment.

As explained in equation 2, the ESI 605 is derived from the EI 604 of a fiber by dividing the EI of the fiber under consideration by the maximum EI derived among all the selected fibers, and a higher ESI implies less environmental impact, hence a more sustainable environment.

Table 1 shows the amount of oxygen produced:

TABLE 1
Amount of oxygen released/Amount of CO₂ absorbed

| | Amount of Oxygen | |
|---|---|---|
| Fiber | released | Amount of CO₂ absorbed |
| Cotton | 8000 Kgs/Hectare (6) | 11000 kgs/hectare/yr |
| | | 23404 kg/acre (6) |
| Hemp | (Data Not Available). | 2500 kgs/hectare (7) |
| | | 5319 kgs/acre (7) |
| Viscose | 2800 O2/acre/year (8) | 1000 kgs/acre (8) |

TABLE 2
Value of Y₁
CO₂ absorption/emission

| Amount of CO₂ absorbed per hectare/year | Score |
|---|---|
| <1000 | 1 |
| 1000-5000 | 2 |
| 5000-10000 | 3 |
| 10000-20000 | 4 |
| >20000 | 5 |
| Negative contribution - CO₂ emission | 5 |

### Renewable Resources Utilisation

TABLE 3
Value of Y₂

| Fiber | Renewable resources utilisation | Value of Y₂ |
|---|---|---|
| Cotton | Yes(4) | 0 |
| Organic Cotton | Yes | 0 |
| Wool | Yes(4) | 0 |
| Hemp | Yes | 0 |
| Nylon 6 | No(4) | 5 |
| Nylon 66 | No(4) | 5 |
| Polyester | No(4) | 5 |
| PP | No(4) | 5 |
| Acrylic | No(4) | 5 |
| Viscose | Yes(4) | 0 |

Scoring scheme for resources

| Resources | Score |
|---|---|
| Renewable | 0 |
| Non-renewable | 5 |

TABLE 4
Value of Y₃

| Fiber | Use of Land | Value of Y₃ |
|---|---|---|
| Cotton | Direct | 5 |
| Organic Cotton | Direct | 5 |
| Wool | Direct | 5 |
| Hemp | Direct | 5 |
| Nylon 6 | Indirect | 2.5 |
| Nylon 66 | Indirect | 2.5 |
| Polyester | Indirect | 2.5 |
| PP | Indirect | 2.5 |
| Acrylic | Indirect | 2.5 |
| Viscose | Direct | 5 |

Scoring scheme for land use

| Usage of Land | Score |
|---|---|
| Direct | 5 |
| Indirect | 2.5 |

### Usage of Synthetic Fertilizers and Pesticides

| | Use of fertilizers and | |
|---|---|---|
| Fiber | pesticides | Value of Y₄ |
| Cotton | Yes | 5 |
| Organic Cotton | No | 0 |
| Wool | Yes | 5 |
| Hemp | Yes | 5 |
| Nylon 6 | No | 0 |
| Nylon 66 | No | 0 |
| Polyester | No | 0 |
| PP | No | 0 |
| Acrylic | No | 0 |
| Viscose | No | 0 |

Scoring scheme for fertilizers and pesticides

| Usage of fertilizers and pesticides | Score |
|---|---|
| Yes | 5 |
| No | 0 |

### Fiber Recyclability and Biodegradability

TABLE 6
Values of Y₅ and Y₆

| Fiber | Recyclability | Value of Y₅ | Biodegradability | Value of Y₆ |
|---|---|---|---|---|
| Cotton | Difficult (4) | 5 | Yes (4) | 0 |
| Organic | Difficult (4) | 5 | Yes (4) | 0 |
| Cotton | | | | |
| Wool | Easy (4) | 0 | Yes (4) | 0 |
| Hemp | Difficult | 5 | Yes | 0 |
| Nylon 6 | Easy (4) | 0 | No (4) | 5 |
| Nylon66 | Easy (4) | 0 | No (4) | 5 |
| Polyester | Easy (4) | 0 | No (4) | 5 |
| PP | Difficult (9) | 5 | No (9) | 5 |
| Acrylic | Difficult (9) | 5 | No (9) | 5 |
| Viscose | Difficult (4) | 5 | Yes (4) | 0 |

Scoring scheme for Recyclability and Biodegradability

| | Score |
|---|---|
| Recyclability | |
| With Ease | 0 |
| With Difficulty | 5 |
| Biodegradability | |
| Yes | 0 |
| No | 5 |

### EI_{LCIA}-LCIA Categories

### Life Cycle Impact Assessment of Textile Fibers

TABLE 7
Energy needs

| | Energy use in MJ Per Kg of |
|---|---|
| Fibers | fiber |
| Conventional Cotton | 60 (10) |
| Organic Cotton | 54 (10) |
| Flax | 10 (11) |
| Wool | 63 (12) |
| Viscose | 100 (12) |
| Polypropylene | 115 (12) |
| Polyester | 125 (12) |
| Acrylic | 175 (12) |
| Nylon 66 | 138.65 (13) |
| Nylon 6 | 120.47 (13) |

### Water Requirements

TABLE 8
Water requirements

| Fibers | Water requirement Per Kg of fiber | |
|---|---|---|
| Conventional Cotton | 22000 | Kgs (10) |
| Nylon 6 | 185 | Kgs (13) |
| Flax | 214 | Litres (14) |
| Polypropylene | 43 | Kgs (13) |
| Polyester | 62 | Kgs (13) |
| Nylon 66 | 663 | Kgs (13) |
| Organic cotton | 24000 | Kgs (10) |
| Wool | 125 | L; 5-40 Litres (Scouring) (14) |
| Viscose | 640 | Litres (14) |
| Acrylic | 210 | Litres (14) |

CO₂ Emission from Fibers (Cradle to Gate of Fiber)

TABLE 9
CO₂ emission from fibers (cradle to gate)

| | CO₂ Emission - |
|---|---|
| Fiber | Kg CO₂ Per Kg of Fiber |
| Nylon 6 | 5.5 (13) |
| Nylon 66 | 6.5 (13) |
| Viscose | 9 (15) |
| | (−3.5 for bio-mass credit) |
| Acrylic | 5 (15) |
| Polyester | 2.8 (13) |
| Organic Cotton | 2.5 (10) |
| Wool | 2.2 (15) |
| Conventional Cotton | 6 (10) |
| Flax | 3.8 (16) |
| Polypropylene (PP) | 1.7 (13) |

### Calculation of Indicators by LCIA Method

By considering the above explained three factors 600 for life cycle inventory, life cycle impact assessment 602 is calculated using SIMAPRO 7.2 version of LCA software (17). Among the various impact assessment methods available (18), Eco-indicator'99 (Hierarchist version) method was selected to calculate the damage created by the fibers in the following categories, which can help in evaluating the environmental impact and the sustainability of the fiber production process:
I. Damage to Human Health (DALY) (Disability-Adjusted Life Years)
II. Damage to Eco System Quality (PDF*m2yr) (Potentially Disappeared Fraction of plant species)
III. Damage to Resources (MJ Surplus) (Additional energy requirement to compensate lower future ore grade) (19-20).

### Results of Life Cycle Assessment Indicators

TABLE 10
Life cycle impact assessment results

| | Damage to | Damage to Eco | Damage to |
|---|---|---|---|
| | Human Health | System Quality | Resources |
| Fiber | (DALY) (Scale:1000:1) | (PDF * m2yr) | (MJ Surplus) |
| Cotton | 0.5 | 3.2 | 9.4 |
| Organic Cotton | 0.4 | 2.9 | 8.5 |
| Wool | 0.5 | 3.4 | 9.9 |
| Flax | 0.08 | 0.5 | 1.6 |
| Nylon6 | 1 | 6.5 | 18.9 |
| Nylon 66 | 1.1 | 7.5 | 21.7 |
| Polyester | 1 | 6.8 | 19.6 |
| Polypropylene | 0.9 | 6.2 | 18 |
| (PP) | | | |
| Acrylic | 1.4 | 9.5 | 27.4 |
| Viscose | 0.8 | 5.4 | 15.7 |

Damage to Human Health (DALY)

| | |
|---|---|
| <0.1 | 0 |
| 0.11-0.3 | 1 |
| 0.31-0.6 | 2 |
| 0.61-0.9 | 3 |
| 0.91-1.2 | 4 |
| >1.21 | 5 |

Damage to Eco System Quality (PDF * m2yr)

| | |
|---|---|
| <0.5 | 0 |
| 0.6-2 | 1 |
| 2.1-4 | 2 |
| 4.1-6 | 3 |
| 6.1-8 | 4 |
| >8.1 | 5 |

Damage to Resources (MJ Surplus)

| | |
|---|---|
| <2 | 0 |
| 2.1-5 | 1 |
| 5.1-10 | 2 |
| 10.1-15 | 3 |
| 15.1-20 | 4 |
| >20.1 | 5 |

Scoring system based on LCIA indicators

TABLE 11
Values of Y₇

| | Damage to | Damage to Eco | Damage to | Value of |
|---|---|---|---|---|
| Fiber | Human Health | System Quality | Resources | Y₇ |
| Cotton | 2 | 2 | 2 | 6 |
| Organic | 2 | 2 | 2 | 6 |
| Cotton | | | | |
| Wool | 2 | 2 | 2 | 6 |
| Flax | 0 | 0 | 0 | 0 |
| Nylon6 | 4 | 4 | 4 | 12 |
| Nylon 66 | 4 | 4 | 5 | 13 |
| Polyester | 4 | 4 | 4 | 12 |
| PP | 3 | 4 | 4 | 11 |
| Acrylic | 5 | 5 | 5 | 15 |
| Viscose | 3 | 4 | 4 | 11 |

### Quantification of Recyclability Potential Index (RPI) of Textile Fibres

For the quantification of recyclability, another model is provided. Recyclability Potential Index (RPI) cannot be decided by considering a single factor of a textile fibre/any material. It is a composite factor, taking into account of numerous factors in various angles. Though there are many possible factors to be looked at, at this moment, only environmental and economical sides are taken into consideration to derive RPI.

RPI=ΣEGI₁+EGI₂,
Where
   EGI₁—Environmental Gain Index
   EGI₂—Economical Gain Index.

EG₁=ΣX₁+X₂+X₃+X₄,
Where
   X₁=Saving potential resources
   X₂=Environmental impact caused by producing virgin fibres
   X₃=Environmental impact due to land filling
   X₄=Environmental benefits gained out of recycling versus incineration

EG₂=x₁/x₂,
Where
   x₁=Price of recycled fibre;
   x₂=Price of virgin fibre.

### Derivation of Recyclability Potential Index (Rpi) of Textile Fibres Environmental Gain Index—Data Collection

### Saving Potential Resources

To produce 1 kg of a textile fibre, an enormous amount of resources are spent. The two major potential resources being spent in producing any textile fibre are energy and water. The following Table 1 lists the energy and water needs for the production of 1 kg of virgin fibre.

TABLE 1
Energy and Water needs

| | Energy use in MJ | Water requirement | |
|---|---|---|---|
| Fibre | Per Kg of fibre | Per Kg of fibre | |
| Nylon 6 | 120.47 (13) | 185 | Kgs (13) |
| Nylon 66 | 138.65 (13) | 663 | Kgs (13) |
| Viscose | 100 (12) | 640 | Litres (14) |
| Acrylic | 175 (12) | 210 | Litres (14) |
| Polyester | 125 (12) | 62 | Kgs (13) |
| Wool | 63 (12) | 125 | L; 5-40 Litres (Scouring) (14) |
| Cotton | 60 (10) | 22000 | Kgs(10) |
| PP | 115 (12) | 43 | Kgs (13) |
| LDPE | 78.08 (13) | 47 | Kgs (13) |
| HDPE | 76.71 (13) | 32 | Kgs (13) |

### Environmental Impact Caused by Producing Virgin Fibers

To arrive at these results, the above said impacts are modeled with the aid of Simapro 7.2 version of software. Environmental impacts in the above categories are modeled for producing 1 kg of virgin fibre with the aid of suitable datasets available in Simapro 7.2 version. Ecological footprint is modeled by Ecological Footprint V1.00, carbon footprint was modeled by IPCC 2007 GWP 100a method and ecological damage was quantified by Ecoindicator'99 method, where only human health impacts are considered. The corresponding results of all ten fibres can be seen from Table 2.

TABLE 2
Environmental impacts caused during virgin fibre production

| | | | Ecological |
|---|---|---|---|
| | Total Ecological | IPCC GWP 100a in | Damage - Human |
| Fibre | Footprint in Pt | kg CO2 eq | Health in mPt |
| Nylon 6 | 16.2 | 9.2 | 109.5 |
| Nylon 66 | 20.2 | 8.0 | 91.5 |
| Viscose | 36.4 | 1.8 | 125.8 |
| Acrylic | 7.8 | 3.2 | 36.8 |
| Polyester | 7.9 | 2.8 | 38.6 |
| Cotton | 0.001 | 0.4 | 82.4 |
| Wool | 604.4 | 86 | 2485 |
| PP | 5.3 | 2.0 | 22 |
| LDPE | 6.0 | 2.1 | 25.6 |
| HDPE | 5.1 | 1.9 | 22.5 |

### Environmental Impact Due to Land Filling

To model this scenario, the environmental impact of keeping 1 kg of any textile fibre under consideration is modeled with the aid of Simapro 7.2 version of LCA software. As a last step, environmental effects are measured by means of ecological, carbon footprints and ecological damage in terms of human health. The results of this scenario are given in Table 3.

TABLE 3
Environmental impacts due to land filling

| | Total Ecological | IPCC GWP 100a in | Human Health in |
|---|---|---|---|
| Fibre | Footprint in mPt | g CO2 eq | mPt |
| Nylon 6 | 89.7 | 89.7 | 108.3 |
| Nylon 66 | 89.7 | 89.7 | 108.93 |
| Viscose | 77.5 | 70.0 | 20.0 |
| Acrylic | 77.5 | 70.0 | 20.0 |
| Polyester | 77.5 | 70.0 | 20.0 |
| Cotton | 77.5 | 70.0 | 20.0 |
| Wool | 77.5 | 70.0 | 20.0 |
| PP | 92.8 | 96.8 | 42.5 |
| LDPE | 101.7 | 112.6 | 50.3 |
| HDPE | 101.7 | 112.6 | 50.3 |

### Environmental Benefits Gained Out of Recycling Versus Incineration

TABLE 4
Environmental benefits of Recycling Vs Incineration

| | Energy conserved, in | Energy generated, in |
|---|---|---|
| Fibre | kilowatt hours per ton (1) | kilowatt hours per ton (2) |
| Nylon 6 (21) | 4889 | 611 |
| Nylon 66 (21) | 4889 | 611 |
| Viscose (21) | 4889* | 611* |
| Acrylic (21) | 4889 | 611 |
| Polyester (21) | 7203 | 1761 |
| Cotton (21) | 3531 | 611 |
| Wool (22) | 16389 | Data Not Available |
| PP (21) | 5776 | 1407 |
| LDPE (21) | 6330 | 1222 |
| HDPE (21) | 6232 | 1761 |

(1) Substituting secondary materials for virgin raw materials.
(2) Incinerating municipal solid waste.
*Data taken from the value of synthetics.

### Economical Gain Index—Data Collection

TABLE 5
Prices of Virgin and Recycled Fibres and EGI₂

| | | | Recycled | | |
|---|---|---|---|---|---|
| | Virgin Fibre | | Fibre | | |
| | Prices in | Description | Prices in | | |
| Fibre | Yuan/Ton. | and Source | Yuan/Ton | Description and Source | EGI₂ |
| Nylon 6 | 24300 | Conventional | 18800 | Grade 1. Recycled chips from | 0.77 |
| | | (23) | | waste yarns. Original colour with | |
| | | | | lustre (29) | |
| Nylon 66 | 63500 | 15D/7F DTY | 20000 | Grade 1. Recycled chips from | 0.31 |
| | | (24) | | waste yarns. Original colour with | |
| | | | | lustre. (29) | |
| Viscose | 19355 | 1.5D VSF (23) | 5000 | Waste Viscose Fibre (30) | 0.26 |
| Acrylic | 22800 | 1.5D (23) | 11300 | Original colour PMMA broken | 0.50 |
| | | | | materials. Can be directly used or | |
| | | | | be granulated. (31) | |
| Polyester | 10131 | 1.4D PSF(23) | 8339 | Re-PSF-High quality white 1.5 D | 0.82 |
| | | | | (23) | |
| Cotton | 16877 | Cotton 328(23) | 4000 | Length of Fiber: 1.5-2.5 cm (32) | 0.24 |
| Wool | 53262 | AWEX EMI | 9000 | Waste Wool in different quality | 0.17 |
| | | (25) | | level, good softness. Can be used | |
| | | | | in many methods, mainly used for | |
| | | | | spinning and man-made wool flat | |
| | | | | (33) | |
| PP | 11600 | 1.5D * 38 mm | 7500 | Transparent, pure and clean. Can | 0.65 |
| | | (26) | | be directly used or be granulated. | |
| | | | | (34) | |
| LDPE | 10550 | (27) | 6700 | Transparent, transition waste, | 0.64 |
| | | | | pure. Can be re-used or be | |
| | | | | granulated (35) | |
| HDPE | 9100 | (28) | 6600 | Transparent, transition waste, | 0.73 |
| | | | | pure. Can be re-used or be | |
| | | | | granulated. (36) | |

TABLE 6
Scaling Template
Energy (MJ)

| | |
|---|---|
| <50 | 1 |
| 51-100 | 2 |
| 101-150 | 3 |
| 151-200 | 4 |
| >201 | 5 |

E.I. of Virgin - EFP

| | |
|---|---|
| <5 | 1 |
| 5.1-10 | 2 |
| 10.1-20 | 3 |
| 20.1-30 | 4 |
| >30.1 | 5 |

E.I. of Virgin - HHI

| | |
|---|---|
| <20 | 1 |
| 21-40 | 2 |
| 41-60 | 3 |
| 61-80 | 4 |
| >81 | 5 |

E.I. of Landfill- CFP

| | |
|---|---|
| <50 | 1 |
| 51-100 | 2 |
| 101-150 | 3 |
| 151-200 | 4 |
| >201 | 5 |

Energy Conserved

| | |
|---|---|
| >12001 | 1 |
| 12000-9001 | 2 |
| 9000-6001 | 3 |
| 6000-3001 | 4 |
| <3000 | 5 |

Water (Kgs)

| | |
|---|---|
| <100 | 1 |
| 101-200 | 2 |
| 201-300 | 3 |
| 301-400 | 4 |
| >401 | 5 |

E.I. of Virgin - CFP

| | |
|---|---|
| <2 | 1 |
| 2.1-4 | 2 |
| 4.1-6 | 3 |
| 6.1-8 | 4 |
| >8.1 | 5 |

E.I. of Landfill-EFP

| | |
|---|---|
| <50 | 1 |
| 51-100 | 2 |
| 101-150 | 3 |
| 151-200 | 4 |
| >201 | 5 |

E.I. of Landfill- HHI

| | |
|---|---|
| <20 | 1 |
| 21-40 | 2 |
| 41-60 | 3 |
| 61-800 | 4 |
| >81 | 5 |

EGI₂

| | |
|---|---|
| >0.81 | 1 |
| 0.8-0.61 | 2 |
| 0.6-0.41 | 3 |
| 0.4-0.21 | 4 |
| <0.20 | 5 |

TABLE 7
EGI₁, EGI_{1,} and RPI

| Fibre | EGI₁ | EGI₂ | RPI |
|---|---|---|---|
| Nylon 6 | 31 | 2 | 33 |
| Nylon 66 | 34 | 4 | 38 |
| Viscose | 27 | 4 | 31 |
| Acrylic | 22 | 3 | 25 |
| Polyester | 18 | 1 | 19 |
| Cotton | 23 | 4 | 27 |
| Wool | 25 | 5 | 30 |
| PP | 18 | 2 | 20 |
| LDPE | 21 | 2 | 23 |
| HDPE | 20 | 2 | 22 |

TABLE 8
RPI and Ranking in terms of Recyclability

| | | Ranking in terms |
|---|---|---|
| Fibre | RPI | of Recyclability |
| Nylon 6 | 33 | 9 |
| Nylon 66 | 38 | 10 |
| Viscose | 31 | 8 |
| Acrylic | 25 | 5 |
| Polyester | 19 | 1 |
| Cotton | 27 | 6 |
| Wool | 30 | 7 |
| PP | 20 | 2 |
| LDPE | 23 | 4 |
| HDPE | 22 | 3 |

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

### REFERENCES

(1) Bruntland G. (ed.) (1987) Our common future: The World Commission on Environment and Development. Oxford, Oxford University Press.
(2) SETAC workshop report (1992), A conceptual framework for Life-Cycle Impact Assessment, Edited by James fava, et al, February 1-7, 1992, USA.
(3) SETAC, 1990, A Technical Framework for Life Cycle Assessment, Edited by: James A Fava, et al, August 18-23, Smugglers Notch, Vt.
(4) Chen, H-L.; Burns, L. D. Environmental Analysis of Textile products. Clothing & Textiles Research Journal. 2006, 24(3), 248-261.
(5) J. B. Guinee (Ed.); Handbook on Life Cycle Assessment, Operational Guide to the ISO Standards, Kluwer Academic Publishers, Dordrecht, 2002.
(6) Jordan A. G. Facts about Cotton and Global Warming, www.cottoninc.com/Air . . . Quality/Cotton-and-Global-Warming-Facts/.
(7) Mankowski, J.; Kolodziej, J. Increasing Heat of Combustion of Briquettes Made of Hemp Shives. International Conference on Flax and other Bast Plants. 2008, 344-352.
(8) Benefits of Trees in Urban Areas, http//www.coloradotrees.org/benefits.htm.
(9) Horrocks A R, Hall M E, Roberts D (1997) Environmental consequences of using flame-retardant textiles—a simple life cycle analytical model. Fire and Materials 21(5): 229-234.
(10) Kaillala, M. E.; Nousiainen, P. Environmental profile of cotton and polyester-cotton fabrics. AUTEX Research Journal. 1999, 1(1), 8-20.
(11) What is the energy profile of the textile industry? Retrieved from: http//oecotextiles.wordpress.com/2009/06/16/what-is-the-energy-profile-of-the-textile-industry
(12) Barber, A.; Pellow, G. Life Cycle Assessment New Zealand Merino Industry Merino Wool Total Energy Use and Carbon Dioxide Emissions. The Agri Business Group, 2006.
(13) Boustead, I. Eco-profiles of the European Plastics Industry. Plastics Europe, March 2005.
(14) Laursen, S. E.; Hansen, J.; Bagh, J; Jensen, O. K; Werther, I. Environmental assessment of textiles. Life cycle screening of the production of textiles containing cotton, wool, viscose, polyester or acrylic fibres. Environmental project no. 369. Ministry of the Environment and Energy, Danish Environmental Protection Agency, 1997.
(15) Morris, D. The Fibres, Textile and Textile Manufacturing Industries in China P. R Forecasts and Environmental Considerations, 77^{th} International Wool Textile Organisation congress, Beijing, China, Can be obtained from: www.cirfs.org
(16) Cherett, N.; et al. Ecological Footprint and water analysis of cotton, hemp and polyester, Stockholm environment institute, 2005.
(17) Life Cycle Impact Assessment, http://www.pre.nl/content/Ica-methodology#Impact %20assessment.
(18) Life Cycle Impact Assessment Methods, http://www.earthshift.com/software/simapro/impact-assessment-methods.
(19) Goedkoop, M.; et al. The Eco-indicator'99 A Damage Oriented Method for Life Cycle Impact Assessment. Methodology Report. Second and Third Editions, Amersfoort PRE Consultants. The Netherlands, 2000 & 2001.
(20) Ecoindicator 99 method, http://www.pre.nl/content/eco-indicator-99
(21) Jeffery Morris, Diana Canzoneri, Comparative lifecycle energy analysis: theory and practice, Resource Recycling, November 1992, 25-30.
(22) Peter White, Marina Franke, P. Hindle, Integrated solid waste management: a life cycle inventory, John Wiley & Sons, Inc, pp. 188.
(23) http://www.ccfei.net/pdf/May_{—}2010_China_Report.pdf.
(24) http://info.texnet.com.cn/content/2010-07-09/296,706.html
(25) http://www.woolinfo.net/News/shownews.asp?NewsID=23207
(26) http://info.texnet.com.cn/content/2010-07-07/296,331.html
(27) http://jiage.china.alibaba.com/price/list/c24487-pv-p.html?f_{—}2109=13527
(28) http://jiage.china.alibaba.com/price/list/c24486-pv-p.html?f_{—}4161=100001593
(29) http://www.chinanylon.cn/priceshl.asp
(30) http://www.zz91.com/cn/productdetail400169.html
(31) http://china.worldscrap.com/modules/cn/plastic/cndick_article.php?aid=193675
(32) http://www.diytrade.com/china/2/products/2348061.html
(33) http://www.yuancailiao.net/trade/offerdetail-58401.aspx
(34) http://china.worldscrap.com/modules/cn/plastic/cndick_article.php?aid=193471
(35) http://china.worldscrap.com/modules/cn/plastic/cndick_article.php?aid=193687
(36) http://china.worldscrap.com/modules/cn/plastic/cndick_article.php?aid=193663

We claim:

1. A computer-implemented method for evaluating eco-functional properties of a product, comprising:
providing four inputs including raw materials, process of manufacture, functional properties and ecological properties of the product;
providing five outputs including Quality, Functionality, Human Impact, 3R's (Reduce, Recycle, Reuse), and Environmental Impact;
connecting the inputs and outputs using predetermined rules to generate an eco-functional model; and
wherein the eco-functional properties of the product are evaluated using the eco-functional model to derive an Eco-Functional Index which is computed by the equation: ΣESI+HTI+EII+FI+Eco-I, where ESI is an Ecological Sustainability Index, EII is an Environmental Impact Index, HTI is a Human Toxicity Index, FI is a Functionality Index and Eco-I is an Ecological Index.

2. The method according to claim 1, wherein the product is a textile product.

3. The method according to claim 1, wherein the EII is computed by the equation: ΣCPFI+ERFPI+ELUI, where CFPI is a Carbon Foot Print Index, ERFPI is an Ecological Resources Foot Print Index and ELUI is an Environmental Load Unit Index.

4. The method according to claim 1, wherein the FI is computed by the equation: ΣQI+SI+HSI+PI+CFI+IRI, where SI is a Strength Index, IRI is an Impact Resistance Index, HIS is a Human Safety Index, PI is a Permeability Index, CFI is a Colour Fastness Index, and QI is a Quality Index.

5. The method according to claim 1, wherein the Eco-I is computed by the equation: ΣBI+RUI+RC, where BI is a Biodegradability Index, RUI is a Reusability Index and RCI is a Recyclability Index.

6. The method according to claim 1, wherein the predetermined rules to connect the inputs and the outputs is any one from the group consisting of:
the raw materials input is connected to the environmental impact output;
the raw materials input is connected to the 3R's output;
the raw materials input is connected to the Human Impact output;
the process of manufacture input is connected to the Human Impact output and Environmental Impact output;
the functional properties input is connected to the Quality output and Functionality output; and
the ecological properties input is connected to the Human Impact output, Environmental Impact output and 3R's output.

7. The method according to claim 1, wherein the Environmental Impact output includes Eco-Damage, ecological footprint and carbon footprint.

8. The method according to claim 1, wherein the raw materials input is quantified by the EII and the ESI.

9. The method according to claim 5, wherein the ecological properties input is quantified by RUI, RCI, and BI.

10. A system for evaluating eco-functional properties of a product, comprising:
an input module to receive four inputs including raw materials, process of manufacture, functional properties and ecological properties of the product;
an output module to generate five outputs including Quality, Functionality, Human Impact, 3R's (Reduce, Recycle, Reuse), and Environmental Impact;
a processing module to connect the inputs and outputs using predetermined rules to generate an eco-functional model; and
wherein the eco-functional properties of the product are evaluated using the eco-functional model to derive an Eco-Functional Index which is computed by the equation: ΣESI+HTI+EII+FI+Eco-I, where ESI is an Ecological Sustainability Index, EII is an Environmental Impact Index, HTI is a Human Toxicity Index, FI is a Functionality Index and Eco-I is an Ecological Index.
